(19) United States
(12) Patent Application Publication
(10) Pub. No.: US 2022/0355415 A1
(43) Pub. Date: Nov. 10, 2022

(54) PRODUCTION METHOD FOR WELDING A COPPER CONDUCTOR TO A WORKPIECE, WORKPIECE, AND VEHICLE

(71) Applicant: Robert Bosch GmbH, Stuttgart (DE)

(72) Inventor: Lukas Alter, Stuttgart (DE)

(21) Appl. No.: 17/618,842

(22) PCT Filed: Jul. 9, 2020
(86) PCT No.: PCT/EP2020/069409

§ 371 Date: Dec. 13, 2021

(30) Foreign Application Priority Data
Jul. 25, 2019 (DE) 10 2019 211 070.3

(51) Int. Cl. B23K 26/211; B23K 26/244; B23K 26/70; B23K 26/60; B23K 26/32; B23K 26/12

(52) U.S. Cl. CPC B23K 26/211; B23K 26/244; B23K 26/702; B23K 26/60; B23K 26/32; B23K 26/123; B23K 2103/12

(57) ABSTRACT

A production method for welding a copper conductor to an electrical contact element of a workpiece for electrical contacting. The contact element has a first copper alloy, and the method has the following method steps: mechanical contacting between the copper conductor and the contact element at a join of the contact element, the welding of the copper conductor to the contact element being carried out with the aid of a focused laser beam, the laser beam having a wavelength of less than or equal to 0.6 μm, and a welded seam is produced which has a welding depth that is greater than or equal to 100 μm.

### FIELD

The present invention relates to a production method for welding a copper conductor to a workpiece at a contact element in order to establish electrical contacting. The present invention also relates to a workpiece having a welded seam, the welded seam having a welding depth that is greater than or equal to 100 μm. The present invention furthermore relates to a vehicle having the workpiece according to the present invention.

### BACKGROUND INFORMATION

A noticeable increase in the electrification of the public and private passenger transport systems requires new techniques for producing electrical modules. For instance, many electronic modules of the described application fields require electrical conductors which include a copper alloy and have a high current-carrying capability in combination with sufficient strength.

Laser steel welding or welding with the aid of a laser beam has become established as a flexible method in the industrial production. However, the low absorption of laser radiation of typical welding lasers featuring a wavelength of approximately 1 μm through copper requires a high intensity at the module to even allow for the realization of a welding process. In addition, a high thermal conductivity of copper considerably hampers a sufficient heat input for the welding or at least for the melting. Once the melting temperature has been reached, the absorption of the laser radiation abruptly rises by a factor of 2 to 3 from a wavelength of 1 μm of copper, while the thermal conductivity drops roughly by a factor of 2. This leads to a strong increase in the heat input together with a sudden development of a vapor channel (keyhole) featuring a large aspect ratio (ratio of keyhole depth to keyhole diameter), and hydrogen pores can result which reduce the strength of the welded seam.

An object of the present invention is to improve a production method for welding between components which each include a copper material.

### SUMMARY

According to the present invention, the above object may achieved.

The present invention relates to a production method for welding a copper conductor to an electrical contact element of a workpiece for the electrical contacting, in particular for the electrical contacting of the workpiece. The contacting element includes a copper alloy. In accordance with an example embodiment of the present invention, the method starts with a mechanical contacting between the copper conductor and the contact element of the workpiece at a join of the contact element. In other words, the copper conductor is placed on the contact element or the copper conductor joined to the contact element. The copper conductor is then welded to the contact element of the workpiece with the aid of a focused laser beam, e.g., using seam welding or welding of a butt joint. The laser beam has a wavelength of less than or equal to 0.6 μm. The laser beam advantageously has a wavelength of green light in the visible spectral range such as a wavelength of 0.515 μm. The welding advantageously creates a welded seam having a welding depth that is greater than or equal to 100 μm. Because of the method according to the present invention, the absorption of radiation in the copper rises greatly because copper absorbs wavelengths below 0.6 μm to a greater degree. This advantageously makes it possible to avoid splatter during the welding operation.

In one embodiment of the present invention, the copper alloy of the contact element of the workpiece and/or the copper conductor includes at least one alloying element, the alloying element being designed to reduce a development of hydrogen pores caused by the welding or to increase the solubility of hydrogen in solid copper and/or to reduce the solubility of hydrogen in liquid copper. The alloying element is advantageously titanium and/or silicon and/or aluminum. After the welding operation, this advantageously results in a volume fraction of hydrogen pores in the welded seam of less than 10%, and especially preferred, a volume fraction of hydrogen pores in the welded seam of less than 2%.

In a further development of the present invention, prior to the mechanical contacting, a foil and/or a powder and/or a roll-cladded semifinished product and/or a wire is/are supplied in the present method. The foil and/or the powder and/or the roll-cladded semifinished product and/or the wire has/have at least one chemical element, the foil and/or the powder and/or the roll-cladded semifinished product and/or the wire having the chemical element being set up in each case to reduce a development of hydrogen pores caused by the welding and to increase the solubility of hydrogen in solid copper and/or to reduce the solubility of hydrogen in liquid copper. The foil and/or the powder and/or the roll-cladded semifinished product and/or the wire include or include(s) in particular titanium and/or silicon and/or aluminum as a chemical element. Next, the foil and/or the powder and/or the roll-cladded semifinished product and/or the wire is/are placed directly at the join of the contact element. In this further development, the mechanical contacting between the provided copper conductor and the contact element is carried out with the aid of the foil and/or the powder and/or the roll-cladded semifinished product and/or the wire, whereby the foil and/or the powder and/or the roll-cladded semifinished product and/or the wire is/are situated in the region of the join between the contact element and the copper conductor after the mechanical contacting. This embodiment provides the advantage that after the welding operation or the welding, a volume fraction of hydrogen pores that amounts to less than 10% results in the welded seam; in an especially preferred manner, a volume fraction of hydrogen pores of less than 2% results in the welded seam.

In one embodiment of the present invention, the copper conductor and/or the contact element of the workpiece has/have a coating, which includes at least the chemical element. The coating with the element is designed to reduce a development of hydrogen pores caused by the welding and to increase the solubility of hydrogen in solid copper and/or to reduce the solubility of hydrogen in liquid copper. The coating in particular includes titanium and/or silicon and/or aluminum as the chemical element. After the welding, this embodiment advantageously produces a volume fraction of hydrogen pores in the welded seam of less than 10%, and especially preferably, a volume fraction of hydrogen pores of less than 2% in the welded seam.

It may furthermore be provided that an ambient atmosphere at the join during the welding has a reduced humidity. The humidity of the ambient atmosphere preferably amounts to less than or equal to 10%. The humidity preferably amounts to less than or equal to 5%. Because of this embodiment, a volume fraction of hydrogen pores in the welded seam after the welding amounts to less than 4%, the resulting volume fraction of hydrogen pores in the welded seam in particular being a function of the first copper alloy.

In one advantageous embodiment of the present invention, the ambient atmosphere at the join during the welding contains an inertial gas, and the inertial gas preferably contains nitrogen, argon and/or helium. After the welding, this embodiment advantageously produces a volume fraction of hydrogen pores in the welded seam of less than 10%; in a particularly preferred manner, a volume fraction of hydrogen pores in the welded seam amounts to less than 2%, the resulting volume fraction of hydrogen pores in the welded seam particularly being a function of the first copper alloy.

The present invention also relates to a workpiece. More specifically, the workpiece is an electrical subassembly, a circuit board or an LTCC substrate. The workpiece has an electrical contact element, which includes a copper alloy. This contact element is integrally welded to a copper conductor for the purpose of establishing an electrical contact, a welded seam in particular having been created between the contact element and the copper conductor. A welding depth of the welded seam is greater than or equal to 100 μm. Moreover, the welded seam has a volume fraction of hydrogen pores of less than or equal to 10%, the welded seam in particular including a volume fraction of hydrogen pores of less than or equal to 4%. The workpiece according to the present invention advantageously exhibits high strength at the welding join. In addition, the electrical contact advantageously has a high-current capacity.

In a further refinement of the workpiece of the present invention, the welded seam has a volume fraction of hydrogen pores of less than or equal to 2% and the welded seam particularly includes no hydrogen pores. This advantageously increases the strength of the electrical contacting or of the welded seam.

In a further embodiment of the workpiece of the present invention, a foil and/or a powder and/or a roll-cladded semifinished product and/or a wire, which has/have at least one chemical element, is/are at least partly situated around the region of the join between the contact element and the copper conductor. The element is designed to reduce a development of hydrogen pores caused by the welding or to increase the solubility of hydrogen in solid copper and/or to reduce the solubility of hydrogen in liquid copper. In an advantageous manner, the foil and/or the powder and/or the roll-cladded semifinished product and/or the wire contain(s) titanium and/or silicon and/or aluminum as the chemical element. As a result, the welded seam has a particularly low number of pores or a particularly low volume fraction of hydrogen porosity, in particular of less than or equal to 10%, which advantageously increases the strength of the electrical contacting through the welded seam.

In addition, the present invention relates to a vehicle having the workpiece according to the present invention.

Additional advantages result from the following description of exemplary embodiments of the present invention with reference to the figures.

### BRIEF DESCRIPTION OF THE DRAWINGS

FIG. 1A-1C show a workpiece having a copper conductor as a join partner.

FIG. 2 shows a welded seam according to the present method in an air atmosphere.

FIG. 3 shows a diagram pertaining to the temperature dependency of the hydrogen solubility in copper.

FIG. 4 shows a flow diagram of the method.

FIG. 5 shows a diagram pertaining to the temperature dependency of the hydrogen solubility in certain copper alloys.

FIG. 6 shows a workpiece having a copper conductor and foil.

### EXAMPLE EMBODIMENTS OF THE PRESENT INVENTION

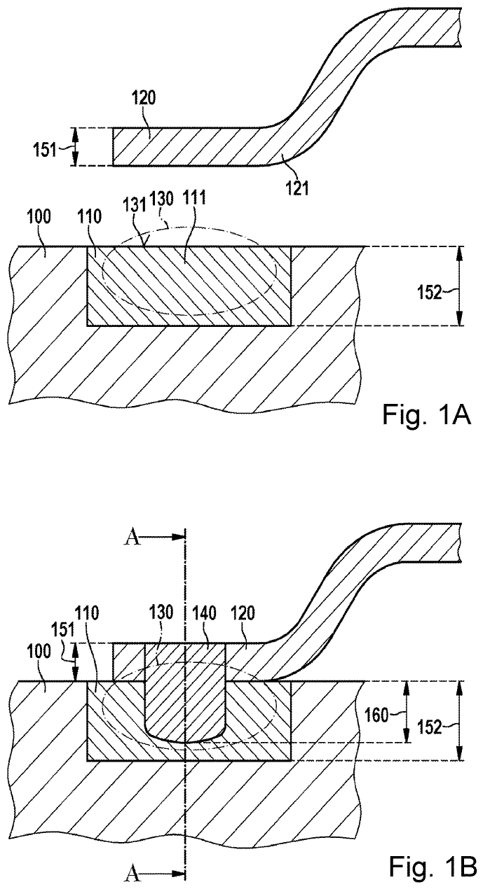

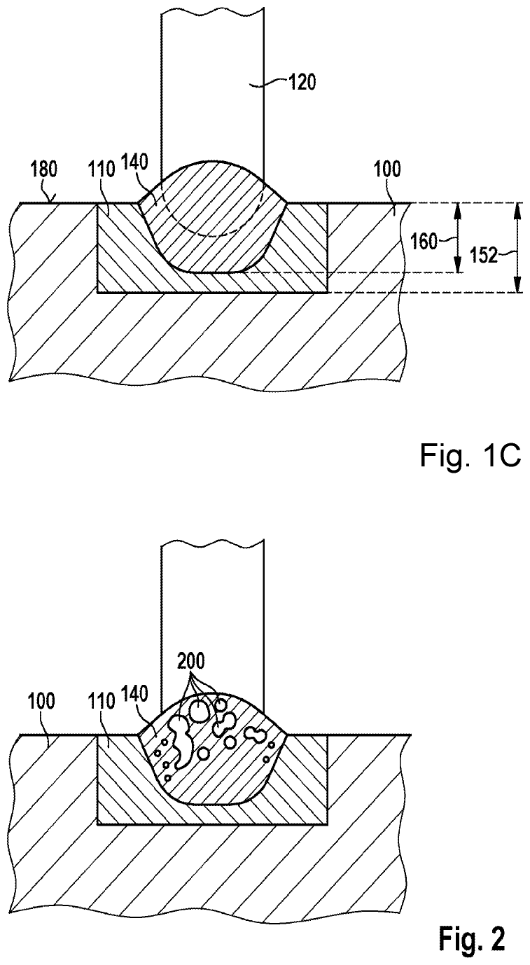

FIG. 1A shows a workpiece 100 and a copper conductor 120 as join partners for the electrical contacting of a contact element 110 of the workpiece. Copper conductor 120 includes a second copper alloy 121. Workpiece 100 is preferably an electrical or electronic subassembly such as a power electronics, a circuit board, an LTCC ceramic, a coated plastic or ceramic substrate or a motor control unit or battery control unit, or a battery or a fuel cell. Workpiece 100 includes contact element 110, which has a first copper alloy 111. First copper alloy 111 and second copper alloy 121 are advantageously identical. As an alternative, first copper alloy 111 and second copper alloy 121 may differ from each other in their material compositions. Contact element 110 has a cross-section featuring a height 152 of preferably 10 μm to 10 mm, and especially in the range of approximately 100 μm. Copper conductor 120 also has a cross-section featuring a height 151 of preferably at least 10 μm to 10 mm, and especially in the range of approximately 100 μm. For example, contact element 110 is designed to be mechanically and electrically contacted with copper conductor 120 at a join 130 or a join surface or contact surface of contact element 110.

FIG. 1B shows workpiece 100 with contact element 110 and copper conductor 120 after a mechanical contacting 330 in the region of a join 130 between contact element 110 and copper conductor 120 of contact element 110 and after welding 340 contact element 110 to copper conductor 120 by seam welding according to the present invention. Alternatively, the welding operation could also be carried out in any other form; for example, welded seam 140 could be disposed in the butt joint. Welded seam 140 is situated between contact element 110 and copper conductor 120 and fastens copper conductor 120 to contact element 110. Welded seam 140 advantageously encompasses the full height 151 of copper conductor 120. Welding depth 160 of welded seam 140 according to the present invention amounts to at least 100 μm. Electric currents between copper conductor 120 and contact element 110 essentially flow through welded seam 140. The strength of welded seam 140 of FIG. 1C is satisfactory insofar as welded seam 140 has a pore volume fraction of only less than 5%, welded seam 140 in particular including no porosity. For example, welded seam 140 of FIG. 1B results when a method according to the present invention for welding the contact element to the copper conductor is carried out in an argon atmosphere and/or under placement of an alloying element and/or a chemical element, the alloying element and/or the chemical element being designed to increase a hydrogen solubility of solid copper or to reduce or prevent a development of hydrogen pores 200 during a welding operation 440. The electrical resistance of the welded seam between contact element 110 and copper conductor 120 is relatively low due to the low or non-existent porosity. This contact between copper conductor 120 and contact element 110 advantageously results in an electrical contact featuring low electrical resistance to the current or energy supply and/or to the current or energy dissipation and/or to the shunting of control currents and/or control signals. In an advantageous manner, the mechanical stability of welded seam 140 is high due to the low volume fraction of less than or equal to 10%.

For a better understanding, FIG. 1C shows a cross-section A-A′ from FIG. 1A. In other words, the illustration of FIG. 1C is rotated by 90° in comparison with FIG. 1B. In alternative embodiments of the present invention, contact element 110 may project beyond surface 180 of workpiece 100 (not shown).

FIG. 2 shows a cross-section A-A′ of workpiece 100 with contact element 110 and copper conductor 120 according to FIG. 1C following a welding method in which green laser radiation is employed under an air atmosphere. Noticeable is the high volume fraction of small and large pores 200 or hydrogen pores of welded seam 140. Pores 200 are filled with gaseous hydrogen, which may develop in the welded seam when the weld pool solidifies following welding 440. Hydrogen pores 200 result in low strength of welded seam 140.

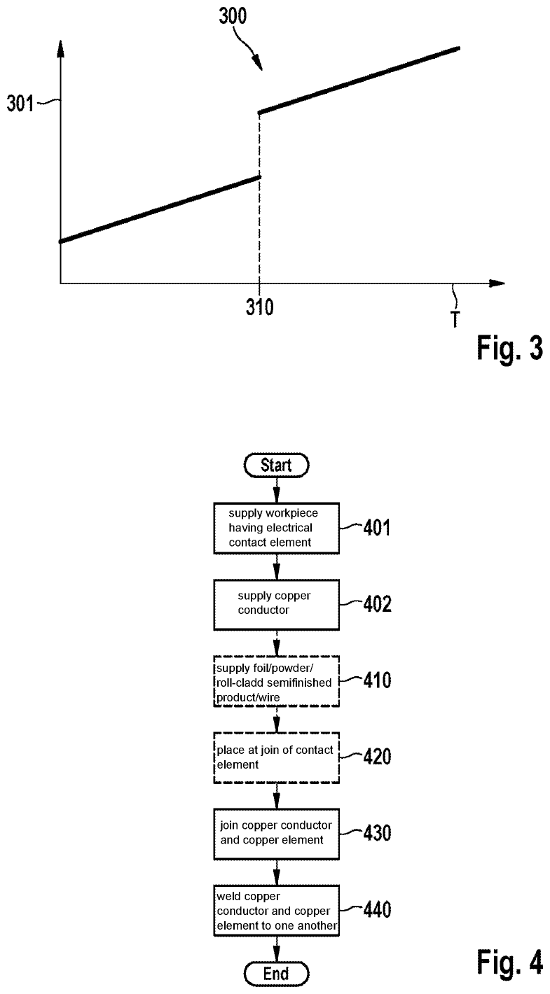

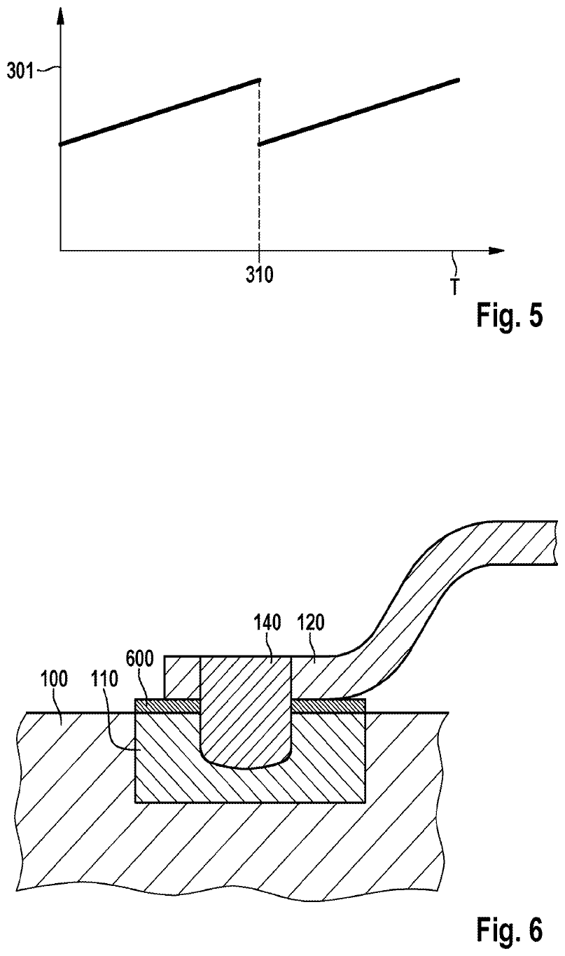

FIG. 3 shows a diagram of a hydrogen solubility 301 of a copper alloy as a function of temperature T. The diagram shown in FIG. 3 is based on a copper alloy that has no additional alloying element for reducing a development of hydrogen pores 200 during a welding process or welding 440 (compare to FIG. 5). Due to a high solubility 301 of hydrogen in this liquid copper alloy, a melt of the copper alloy during a welding process is enriched by hydrogen. When the melt solidifies, an abrupt decrease (approx. factor 3) of hydrogen solubility 301 results once solidification temperature 310 or the melting temperature is reached. The hydrogen enriched in the melt by the welding process suddenly precipitates in gaseous form, and the undesired formation of hydrogen pores 200 occurs in welded seam 140, which reduces in particular the strength of welded seam 140 (see also FIG. 2).

FIG. 4 shows a flow diagram of the present method in the form of a circuit diagram. The method begins with the supply 401 of a workpiece 100 having an electrical contact element 110, and the supply 402 of a copper conductor 120. Electrical contact element 110 includes a first copper alloy 111. Supplied electrical contact element 110 may furthermore have an optional coating, which includes a chemical element. This chemical element is designed to increase the hydrogen solubility of solid copper or at least to reduce the formation of hydrogen pores 200 resulting from a welding operation. Supplied copper conductor 120 includes a second copper alloy 112. Supplied electrical contact element 120 may optionally have a coating that includes a chemical element. This chemical element is designed to increase the hydrogen solubility of solid copper or at least to reduce the formation of hydrogen pores resulting from a welding operation. The first and/or second copper alloy 111, 121 may optionally include at least one alloying element, which is designed to increase the hydrogen solubility of solid copper or at least reduce or prevent a formation of hydrogen pores 200 during a welding operation. The alloying element particularly includes titanium and/or silicon and/or aluminum. Next, in an optional method step, a supply 410 of a foil and/or a powder and/or a roll-cladded semifinished product and/or a wire takes place, which include(s) at least one chemical element, this chemical element being developed to increase the hydrogen solubility of solid copper or to reduce a formation of hydrogen pores 200 caused by a welding operation. The chemical element particularly contains titanium and/or silicon and/or aluminum. In a further optional step 420, the foil and/or the powder and/or the roll-cladded semifinished product and/or the wire is/are placed directly at join 130 of contact element 110. In step 430, contact element 110 and copper conductor 120 are joined. In other words, a mechanical contacting 430 occurs between copper conductor 120 and contact element 110 at a join 130 of contact element 110. It is optionally provided that mechanical contacting 430 is implemented with the aid of the foil and/or the powder and/or the roll-cladded semifinished product and/or the wire disposed at join 130. Next, in step 440, copper conductor 120 and contact element 110 are welded to one another with the aid of a focused laser beam. The laser beam in this welding 440 has a wavelength of less than or equal to 0.6 μm. Preferably, the laser beam has a green wavelength of approximately 0.515 μm. The average output of the laser beam particularly amounts to 0.1 to 5 kW. Welding 440 is carried out under a formation of a vapor channel in the melt or the formation of what is known as a keyhole. In addition, a welded seam 140 having a welding depth 160 that is greater than or equal to 100 μm is produced during welding 440 according to the present invention. It may be provided that welding 440 at join 130 takes place in an atmosphere that has reduced humidity and/or under an inertial gas atmosphere. Put another way, welded seam 140 in these optional embodiments is produced during welding 440 under an artificial atmosphere, or in other words, not under normal ambient air. The reduced humidity of the atmosphere in the region of join 130 or in the region of produced welded seam 140 preferably amounts to less than or equal to 10% during welding 440. In particular, the humidity is preferably less than or equal to 5%.

FIG. 5 schematically illustrates a diagram for the temperature dependency of the hydrogen solubility in a copper alloy that differs from that in FIG. 3, this copper alloy having an optional alloying element. The optional alloying element makes it possible to increase the hydrogen solubility of first and/or second copper alloy 111, 121 in the solid state. As an alternative or in addition, the optional alloying element reduces the hydrogen solubility of the first and/or second copper alloy 111, 121 in the liquid state. The change in the hydrogen solubility of the first and/or second copper alloy 111, 121 may prevent or especially reduce the development of hydrogen pores caused by the precipitation of hydrogen at the melting point or the solidification point during the cooling following welding 440. The optional alloying element in first and/or second copper alloy 111, 121 thus is designed to reduce or prevent the formation of hydrogen pores 200 during a welding operation.

FIG. 6 shows a workpiece 100 having a contact element that corresponds to the view in FIG. 1B, the contact element mechanically and electrically contacting a copper conductor. Prior to welding 440 between contact element 110 and copper conductor 120, a foil 600 was positioned in step 420. The foil is melted in the region of welded seam 140. Situated around welded seam 140 between contact element 110 and copper conductor 120 are parts of foil 600 that are not melted. Foil 600 particularly includes a chemical material or a chemical element which is designed to increase the hydrogen solubility of solid copper. Alternatively or additionally, it may be provided to supply a coating of contact element 110 or a coating of copper conductor 120 instead of foil 600, a coating containing the chemical material or chemical element which is designed to increase the hydrogen solubility of solid copper. Foil 600 and/or the coating particularly contain(s) titanium and/or silicon.

1-10. (canceled)

11. A production method for welding a copper conductor to an electrical contact element of a workpiece for electrical contacting, the contact element including a first copper alloy, the method comprising the following steps:
mechanical contacting between the copper conductor and the contact element at a join of the contact element; and
welding the copper conductor to the contact element using a focused laser beam, the laser beam having a wavelength of less than or equal to 0.6 μm, and a welded seam is produced which has a welding depth that is greater than or equal to 100 μm.

12. The method as recited in claim 11, wherein the first copper alloy of the contact element of the workpiece and/or a second copper alloy of the copper conductor includes at least one alloying element, the alloying element being configured to increase a solubility of hydrogen in solid copper.

13. The method as recited in claim 11, wherein the following steps are carried out prior to the mechanical contacting:
supplying a foil and/or a powder and/or a roll-cladded semifinished product and/or a wire, which has at least one chemical element, the foil and/or the powder and/or the roll-cladded semifinished product and/or the wire having the chemical element being configured to increase a solubility of hydrogen in solid copper;
placing the foil and/or the powder and/or the roll-cladded semifinished product and/or the wire directly at the join of the contact element; and
carrying out the mechanical contacting of the copper conductor with the contact element with the aid of the foil and/or the powder and/or the roll-cladded semifinished product and/or the wire.

14. The method as recited in claim 11, wherein the copper conductor and/or the contact element of the workpiece has a coating which includes at least one chemical element, the coating with the chemical element being configured to increase a solubility of hydrogen in solid copper.

15. The method as recited in claim 11, wherein an ambient atmosphere at the join has a reduced humidity during the welding, the humidity of the ambient atmosphere in particular amounting to less than or equal to 10%.

16. The method as recited in claim 11, wherein an ambient atmosphere at the join has a reduced humidity during the welding, the humidity of the ambient atmosphere amounting preferably amounting to less than or equal to 5%.

17. The method as recited in claim 16, wherein the ambient atmosphere at the join during the welding contains an inertial gas.

18. A workpiece having an electrical contact element, the contact element including a first copper alloy, wherein the contact element is integrally welded to a copper conductor for electrical contacting, a welded seam produced by the welding has a welding depth that is greater than or equal to 100 μm, and the welded seam has a volume fraction of hydrogen pores that is less than or equal to 10%.

19. The workpiece as recited in claim 18, wherein the welded seam has a volume fraction of hydrogen pores of less than or equal to 4%.

20. The workpiece as recited in claim 18, wherein the welded seam has a volume fraction of hydrogen pores of less than or equal to 4%.

21. The workpiece as recited in claim 18, wherein the welded seam has no hydrogen pores.

22. The workpiece as recited in claim 18, wherein a foil and/or a powder and/or a roll-cladded semifinished product and/or a wire is/are situated at least partly around a region of a join between the contact element and the copper conductor, the foil and/or the powder and/or the roll-cladded semifinished product and/or the wire has at least one chemical element, the at least one chemical element being titanium and/or silicon and/or aluminum.

23. A vehicle having a workpiece, the workpiece having an electrical contact element, the contact element including a first copper alloy, wherein the contact element is integrally welded to a copper conductor for electrical contacting, a welded seam produced by the welding has a welding depth that is greater than or equal to 100 μm, and the welded seam has a volume fraction of hydrogen pores that is less than or equal to 10%.
